(19) United States
(12) Patent Application Publication
(10) Pub. No.: US 2004/0201701 A1
(43) Pub. Date: Oct. 14, 2004

(54) Camera with wireless virtual storage

(76) Inventor: Shuichi Takagi, Superior, CO (US)

Correspondence Address: MILLER PATENT SERVICES, 2500 DOCKERY LANE, RALEIGH, NC, 27606, US

(21) Appl. No.: 09/947,843

(22) Filed: Sep. 6, 2001

(51) Int. Cl. H04N 5/225; H04N 9/04

(52) U.S. Cl. 348/207.99

(57) ABSTRACT

A method and apparatus for virtual storage of images from an electronic camera in near real time. The camera compresses images taken as either still images or moving video images into a compressed format such as JPEG or MPEG. The images are then sent to an electronic media server via a gateway connection to the Internet. The images can be viewed at a remote location by streaming or download.

### CROSS REFERENCE TO RELATED DOCUMENTS

This application is related to U.S. patent application Ser. No. 09/891,005, filed Jun. 25, 2001 to Giffin, et al., which is hereby incorporated herein by reference.

### FIELD OF THE INVENTION

This invention relates generally to the field of digital photography. More particularly, this invention relates to methods and apparatus for wireless virtual storage of images from a digital camera.

### BACKGROUND OF THE INVENTION

Currently available electronic cameras, including moving video cameras and still image cameras, often permit the user to download images from the camera to a local computer. In addition, several cameras permit the user to download images to a remote storage location using wireless communications. Unfortunately, such cameras are often inconvenient to operate due to the extended download times required to download image files to the remote or local storage location.

### SUMMARY OF THE INVENTION

The present invention relates generally to wireless virtual storage of images from a digital camera. Objects, advantages and features of the invention will become apparent to those skilled in the art upon consideration of the following detailed description of the invention.

In certain embodiments consistent with the present invention, a method and apparatus for virtual storage of images from an electronic camera in near real time is provided. The camera compresses images taken as either still images or moving video images into a compressed format such as JPEG or MPEG. The images are then sent to an electronic media server via a gateway connection to the Internet. The images can be viewed at a remote location by streaming or download.

A digital video camera, consistent with an embodiment of the present invention captures an electronic representation of an image. The electronic representation of the image is converted into a compressed image. A modem encodes the compressed image into a form suitable for transmission. A transmitter transmits the encoded compressed image to a receiving station, wherein the transmission is carried out in near real time.

A digital video camera, consistent with another embodiment has a charge coupled device for capturing an electronic representation of an image. A processor converts the electronic representation of the image into a compressed image. A modem encodes the compressed image into a form suitable for transmission. A transmitter for transmits the encoded compressed image to a receiving station wherein the transmission is carried out in near real time.

A digital camera system, consistent with another embodiment has

a digital camera, having means for capturing an electronic representation of an image. A compression processor converts the electronic representation of the image into a compressed image. A modem encodes the compressed image into a form suitable for transmission. A transmitter transmits the encoded compressed image, wherein the transmission is carried out in near real time. A receiving station receives the transmissions of the encoded compressed image. An electronic media server is provided that can be accessed via the Internet. The receiving station further has means for sending the compressed image to the electronic media server for storage in near real time.

A method of storing an electronic image, consistent with certain embodiments of the present invention, includes receiving an electronic image;

encoding the electronic image; and sending the electronic image to a remote electronic media server in near real time.

An electronic storage medium storing instructions which, when executed on a programmed processor, carry out a method of storing an electronic image consistent with an embodiment of the invention, including receiving an electronic image; encoding the electronic image; and sending the electronic image to a remote electronic media server in near real time.

A method, consistent with embodiments of the invention, of storing video images, includes producing an electronic camera image; sending the electronic camera image to a remotely located electronic media server via a wireless communication in near real time; and storing the image at the electronic media server.

An electronic storage medium storing instructions which, when executed on a programmed processor, carry out a method consistent with embodiments of the present invention of storing video images, includes producing an electronic camera image; sending the electronic camera image to a remotely located electronic media server via a wireless communication in near real time; and storing the image at the electronic media server.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a block diagram of an exemplary digital camera consistent with an embodiment of the present invention.

FIG. 2 is a wireless virtual storage arrangement consistent with an embodiment of the present invention.

FIG. 3 is a flow chart describing operation of an embodiment consistent with the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

Throughout this document, the term “near real time” is used. In many contexts, it is common to refer to events occurring in “real time” or “near real time”. In the present context, the term “near real time” is used to encompass actions that are carried out almost immediately, and is generally synonymous with the common usage of the term “real time”. However, near real time is more accurate since it accounts for minor delays associated with processing actions such as encoding, compressing, etc. Moreover, in the context of wireless communication of data, it is often not possible to avoid the need for some amount of buffering to account for fading and drop-out of radio frequency signals. Thus, the term “near real time” is adopted herein to encompass the communication of images essentially immediately after the capture of the images, and accounts for both processing delays as well as buffering delays associated with problems inherent with the communication medium.

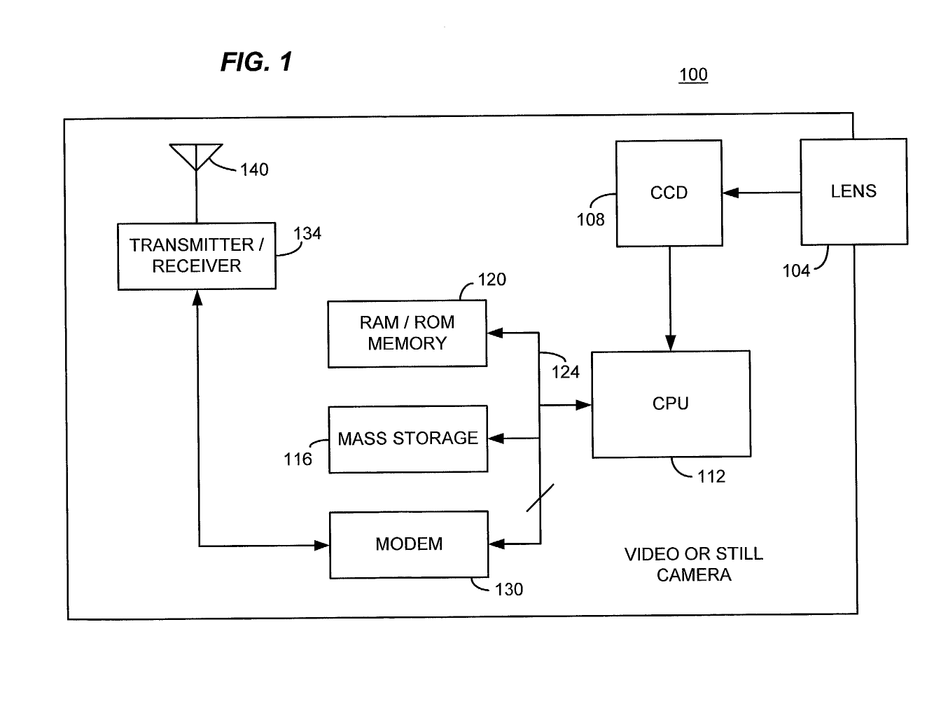

Turning now to FIG. 1, a moving video camera or still image camera 100 is illustrated. A lens elements or elements 104 direct light to a charge coupled device (CCD) 108 that converts light to a digital representation of the image projected thereon by the lens 104. The CCD 108 is read by processor 112 that carries out several operations on the image. The processor 112 may store the image locally to a mass storage device 116 such as a Memory Stick™ device (or any other suitable mass storage), or may simply buffer the image to random access memory forming a part of the processor 112's memory 120. Communication with mass storage device 116 and RAM or ROM memory 120 is carried out through a bus 124 as will be appreciated by those skilled in the art. The processor 112, depending upon whether the camera is a still image camera or a moving video camera, may then carry out a compression operation on the image. In the case of a still camera 100, a compression algorithm such as JPEG (Joint Pictures Expert Group) compression may be carried out. In the case of a moving video camera, MPEG (Moving Pictures Expert Group) compression (e.g., MPEG-2) may be carried out. Such compression may be carried out prior to storage in mass storage device 116 or buffering to a designated portion of RAM memory 120. Processor 112 may also encrypt the images prior to transmission using any suitable compression algorithm.

Once the image or images are compressed (and possibly encrypted) by processor 112 (or a hardware equivalent thereof), in accordance with an embodiment of the present invention, the images are immediately directed to a modem 130, via bus 124, which appropriately formats the compressed image for transmission. In other embodiments, the compressed image is directed to modem 130 during the compression process, as soon as a compressed portion is available for transmission. Modem 130 is coupled to a wireless transmitter/receiver 134 that transmits the compressed image in near real time using an antenna 140. The transmission may be carried out, for example, using Wireless Application Protocol (WAP) or any other suitable wireless transmission protocol. Thus, immediately upon taking a still image or continuously during the process of capturing a moving video image, the image or images are compressed and transmitted in near real time by the camera 100.

Those skilled in the art will appreciate that the configuration of camera 100 illustrated in FIG. 1, is simplified and given by way of example. The exact configuration can vary considerably, and thus the invention should not be considered limited by the architecture shown.

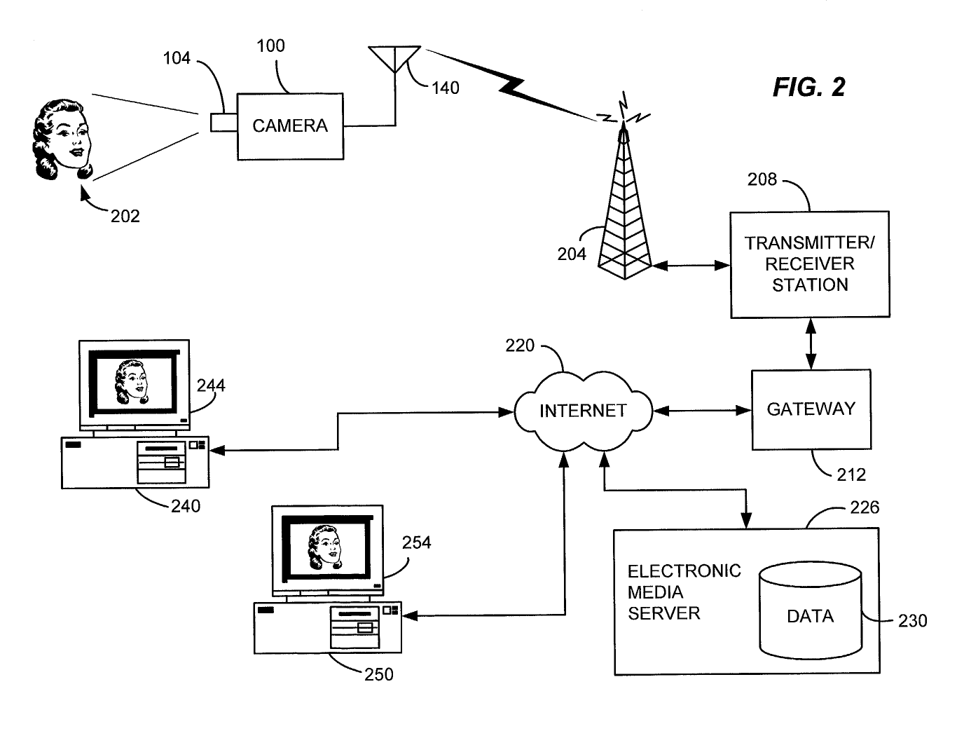

Referring now to FIG. 2, camera 100 captures an image of a target such as 202 and transmits in near real time the image or images being received to a nearby (i.e., within transmission range) base station antenna 204 for a transmitter/receiver station 208. Transmitter/receiver station 208 receives the images and sends the images through a gateway 212 to a specified location on the Internet 220 (e.g., a location designated by a Universal Resource Locator (URL)). The transmitter/receiver station 208 may represent an entry point for Internet service provider (ISP) that provides wireless Internet access services (i.e., a wireless Internet services provider). Transmitter/receiver 208, via gateway 212, thus uses the Internet 220 to forward the images to an electronic media server 226 having data storage capabilities 230 for storing the images received. The images are thus forwarded in near real time to a designated storage area of electronic media server 226. The electronic media server thereby provides storage services to the user by permitting storage of images to a designated area of the server. The user may provide payment to the entity controlling the electronic media server 226 (i.e., a virtual storage provider) in exchange for storage and retrieval services provided. Such payments can be based on any number of business models including payment for storage, payment for retrieval, payments based on amount of storage used and other scenarios without departing from the invention.

The images stored on the electronic media server 226 can be retrieved using a number of scenarios. In one scenario, consider the application of the present technology to a security company. In this embodiment, a computer 240 residing at a computer security company accesses the images stored in the electronic media server 226 via access to a specified URL on the Internet 220. The images received by electronic media server 226 can be streamed to computer 240 as they are received from camera 100 and displayed on monitor 244 in near real time. This permits viewing of activities as they occur and are captured by camera 100. In this embodiment, camera 100 may be situated at a business or residence that is being monitored by the security company. Such a system has a significant advantage over conventional systems in which video tapes are produced at or near the camera for later viewing. In such existing systems, theft of the tape can take place to circumvent the security of the camera. In a wired camera with a hard wired connection to the security company for communication, a criminal can determine where the wiring is and neutralize the camera by severing the wiring. However, those options are not available in the current scenario to anyone attempting to circumvent the security measures of the camera of the present invention.

In another embodiment, real time transmission of moving video images or still images are stored at electronic media server 226 for later retrieval at a computer 250. In one scenario, computer 250 may reside at a relative's residence that may be located anywhere in the world, so that a relative or friend can view images taken by camera 100 and display them on monitor 254. In this embodiment, anyone controlling computer 240 or 250 may, if given appropriate access privileges, accesses the images stored on electronic media server 226 either in near real time or by retrieving images stored previously. Those images may then be either streamed or downloaded from electronic media server 226 for local storage and/or playback at computer 240 or 250. Still images may also be printed locally by computers 240 or 250 by printing to a connected printer (not shown).

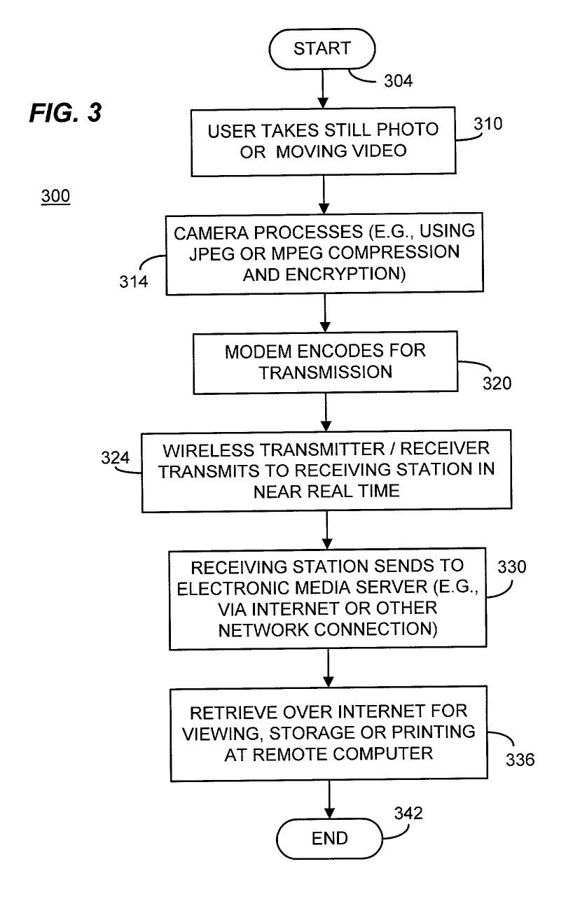

Referring now to FIG. 3, an exemplary process 300 consistent with an embodiment of the present invention is illustrated starting at 304. At 310 a user takes a still photograph or a moving video image at 314. Camera 100 processes the image (for example using JPEG or MPEG compression and possibly encryption) at 314. At 320, modem 130 encodes the image for transmission. At 324 the image or image are wirelessly transmitted by the wireless transmitter/receiver 134 to a receiving station 208 in near real time. At 330 receiving station 208 sends the image or images to an electronic media server 226, for example via the Internet. The image or images can then be retrieved either in real time or at a later time by a remote computer at 336. The process ends at 342.

Those skilled in the art will recognize that the present invention has been described in terms of exemplary embodiments based upon use of a programmed processor, with the program residing in ROM memory 120. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps and associated data used to implement the embodiments described above can be implemented using Read Only Memory (ROM) devices as well as other forms of storage such as for example disc storage, Random Access Memory (RAM) devices, optical storage elements, magnetic storage elements, magneto-optical storage elements, flash memory, core memory and/or other equivalent storage technologies without departing from the present invention. Such alternative storage devices should be considered equivalents.

The present invention, as described in embodiments herein, is implemented using a programmed processor executing programming instructions that are broadly described above in flow chart form and that can be stored on any suitable electronic storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A digital video camera, comprising:
means for capturing an electronic representation of an image;
compressing means for converting the electronic representation of the image into a compressed image;
a modem for encoding the compressed image into a form suitable for transmission; and
a transmitter for transmitting the encoded compressed image to a receiving station, wherein the transmission is carried out in near real time.

2. The apparatus according to claim 1, wherein the image comprises a still image.

3. The apparatus according to claim 2, wherein the compressing means comprises a JPEG encoder.

4. The apparatus according to claim 1, wherein the image comprises a moving video image.

5. The apparatus according to claim 1, wherein the compressing means comprises an MPEG encoder.

6. The apparatus according to claim 1, wherein the transmitting comprises transmitting using a wireless application protocol.

7. The apparatus according to claim 1, wherein the means for capturing comprises a charge coupled device.

8. The method according to claim 1, wherein the compressing means comprises a programmed processor.

9. The method according to claim 1, further comprising means for encrypting the compressed image prior to transmitting.

10. A digital video camera, comprising:
a charge coupled device for capturing an electronic representation of an image;
a processor that converts the electronic representation of the image into a compressed image;
a modem for encoding the compressed image into a form suitable for transmission; and
a transmitter for transmitting the encoded compressed image to a receiving station, wherein the transmission is carried out in near real time.

11. The apparatus according to claim 10, wherein the image comprises a still image.

12. The apparatus according to claim 11, wherein the compressing means comprises a JPEG encoder.

13. The apparatus according to claim 10, wherein the image comprises a moving video image.

14. The apparatus according to claim 13, wherein the compressing means comprises an MPEG encoder.

15. The apparatus according to claim 10, wherein the transmitting comprises transmitting using a wireless application protocol.

16. The method according to claim 10, further comprising means for encrypting the compressed image prior to transmitting.

17. A digital camera system, comprising:
a digital camera, comprising:
means for capturing an electronic representation of an image;
a compression processor that converts the electronic representation of the image into a compressed image;
a modem for encoding the compressed image into a form suitable for transmission;
a transmitter for transmitting the encoded compressed image,
wherein the transmission is carried out in near real time;
a receiving station that receives the transmissions of the encoded compressed image;
an electronic media server that can be accessed via the Internet; and
at the receiving station, means for sending the compressed image to the electronic media server for storage in near real time.

18. The apparatus according to claim 17, further comprising a computer connected to the Internet and receiving the compressed image from the electronic media server.

19. The apparatus according to claim 17, further comprising a computer connected to the Internet and receiving the compressed image from the electronic media server as a streaming video signal.

20. The apparatus according to claim 17, further comprising a computer connected to the Internet and receiving the compressed image from the electronic media server as a streaming video signal in near real time.

21. The apparatus according to claim 17, wherein the image comprises a still image.

22. The apparatus according to claim 21, wherein the compression processor comprises a JPEG encoder.

23. The apparatus according to claim 17, wherein the image comprises a moving video image.

24. The apparatus according to claim 23, wherein the compression processor comprises an MPEG encoder.

25. The apparatus according to claim 17, wherein at the receiving station, the means for sending the compressed image to the electronic media server for storage in near real time comprises means for sending the compressed image through a gateway to the Internet.

26. The apparatus according to claim 17, further comprising an encrypter that encrypts the compressed image prior to transmitting.

27. A method of storing an electronic image, comprising:
receiving an electronic image;
encoding the electronic image; and
sending the electronic image to a remote electronic media server in near real time.

28. The method according to claim 27, wherein the image comprises still image.

29. The method according to claim 28, wherein the image is formatted as a JPEG format image.

30. The method according to claim 27, wherein the image comprises a moving video image.

31. The method according to claim 30, wherein the moving video image is formatted as an MPEG format moving video image.

32. The method according to claim 27, further comprising encrypting the electronic image prior to the sending.

33. An electronic storage medium storing instructions which, when executed on a programmed processor, carry out a method of storing an electronic image, comprising:
receiving an electronic image;
encoding the electronic image; and
sending the electronic image to a remote electronic media server in near real time.

34. A method of storing video images, comprising:
producing an electronic camera image;
sending the electronic camera image to a remotely located electronic media server via a wireless communication in near real time; and
storing the image at the electronic media server.

35. The method according to claim 34, wherein the image is still image.

36. The method according to claim 35, further comprising compressing the still image as a JPEG format image before the sending.

37. The method according to claim 34, wherein the image is a moving video image.

38. The method according to claim 37, further comprising compressing the moving video image as an MPEG format image before the sending.

39. The method according to claim 34, wherein the sending comprises sending the image over the Internet.

40. The method according to claim 34, further comprising retrieving the image over the Internet.

41. The method according to claim 40, wherein the retrieving comprises retrieving the image as a download.

42. The method according to claim 40, wherein the retrieving comprises retrieving the image as a streaming image.

43. An electronic storage medium storing instructions which, when executed on a programmed processor, carry out a method of storing video images, comprising:
producing an electronic camera image;
sending the electronic camera image to a remotely located electronic media server via a wireless communication in near real time; and
storing the image at the electronic media server.
